(19) United States
(12) Patent Application Publication
(10) Pub. No.: US 2024/0380023 A1
(43) Pub. Date: Nov. 14, 2024

(54) BATTERY PACK

(71) Applicants: Hyundai Motor Company, Seoul (KR); Kia Corporation, Seoul (KR)

(72) Inventor: Kyung Mo Kim, Hwaseong-si (KR)

(21) Appl. No.: 18/494,308

(22) Filed: Oct. 25, 2023

(30) Foreign Application Priority Data
May 12, 2023 (KR) 10-2023-0062020

(51) Int. Cl. H01M 10/6555; H01M 10/613; H01M 10/6557; H01M 50/264; H01M 50/51

(52) U.S. Cl. CPC H01M 10/6555; H01M 10/613; H01M 10/6557; H01M 50/264; H01M 50/51

(57) ABSTRACT

An embodiment battery pack includes multiple battery arrays stacked in a height direction, multiple cooling plates disposed between the battery arrays and configured to exchange heat with the battery arrays by surface contact with the battery arrays, each cooling plate having a cooling flow path disposed therein and having an inlet and an outlet which are connected to the cooling flow path, and multiple cooling pipes having first side ends connected to the inlet and the outlet of each cooling plate and second side ends bent to gather at one point and arranged on a same plane.

### CROSS-REFERENCE TO RELATED APPLICATIONS

This application claims the benefit of Korean Patent Application No. 10-2023-0062020, filed on May 12, 2023, which application is hereby incorporated herein by reference.

### TECHNICAL FIELD

The present disclosure relates to a battery pack.

### BACKGROUND

A battery is widely used in mobile devices, auxiliary power devices, and the like. In addition, a battery is attracting attention as a main power source for electric vehicles, hybrid electric vehicles, plug-in hybrid electric vehicles, etc., which are proposed as alternatives to solve various problems such as air pollution caused by conventional gasoline vehicles or diesel vehicles.

For vehicles using such batteries, the efficiency and stability of the battery are very important. In order to secure the efficiency and stability of the battery, it is essential to maintain the proper temperature of the battery. Therefore, a cooling system is becoming increasingly important to maintain the proper temperature of the battery.

Therefore, in a cooling system for managing heat generated by the battery, the efficiency of the heat exchange between a battery cell and the cooling system is important, and the efficiency of the cooling system is improved as the range of surface contact between the battery cells and the cooling plate increases. In addition, when multiple cooling plates (i.e., a plurality of cooling plates) are used, the temperature difference between the cold plates must be eliminated to ensure that the temperature of the battery cell remains constant.

In the prior art, the temperature of coolant flowing into and out of stacked batteries varies greatly from layer to layer, making it difficult to achieve uniform cooling. In particular, a prismatic battery cell is difficult to cool on both sides thereof due to configuration characteristics of the prismatic battery cell and connection structures of a battery module, resulting in low cooling efficiency.

### SUMMARY

The present disclosure relates to a battery pack. Particular embodiments to a battery pack including prismatic battery cells. In some embodiments, the battery pack includes a cooling plate provided in a sandwich structure between stacked battery arrays, and the cooling plate and the battery arrays perform heat exchange more effectively, resulting in excellent cooling efficiency.

Embodiments of the present disclosure relate to a battery pack and, more specifically, to multiple stacked battery arrays and a cooling plate arranged therebetween. A coolant outlet and a coolant inlet are arranged horizontally in parallel on a plane to reduce the temperature difference of the cooling plates on each layer. Battery cells may be horizontally stacked in a sandwich structure, and cooling plates may be provided on both surfaces of the battery cells to maximize cooling efficiency.

A battery pack of embodiments of the present disclosure may include multiple battery arrays stacked in a height direction, multiple cooling plates disposed between the battery arrays to exchange heat with the battery arrays by surface contact with the battery arrays, each cooling plate having a cooling flow path formed therein and having an inlet and an outlet which are connected to the cooling flow path, and multiple cooling pipes having one-side ends, which are connected to an inlet and an outlet of each cooling plate, and the other-side ends, which are bent to gather at one point and arranged on the same plane.

Each of the battery arrays may include multiple battery modules arranged in a horizontal direction, each of the battery modules includes a sensing block and multiple battery cells arranged in the horizontal direction, and the battery modules adjacent to each other may be disposed such that the sensing blocks face each other to constitute the battery array.

A fixing bracket may be coupled to each of both side surfaces of the battery array opposite to the sensing blocks, and fixing brackets of battery arrays vertically disposed with a cooling plate interposed therebetween may be fastened together to the cooling plate.

Each sensing block may be configured to connect connected battery cells in series, and the facing sensing blocks of the battery array have adjacent one-side portions electrically connected to each other and the other-side portions exposed to form terminals, so that the multiple battery cells constituting the battery array may be connected to each other in series.

A connection terminal may be formed on one side of each sensing block, and the connection terminals may be electrically connected to each other by being mechanically fastened while overlapping each other.

The sensing blocks arranged to face each other may be connected to each other through a hinge structure so as to be unfolded or folded, and the sensing blocks may face each other in a folded state.

The sensing blocks connected through the hinge structure may have respective fasteners provided on outer sides thereof, and when the sensing blocks are folded through the hinge structure, the respective fasteners may be fastened to each other while facing each other, thereby keeping the sensing blocks facing each other.

A sensing connector is provided on the outer side of each sensing block so that each sensing connector is exposed outward when the sensing blocks are folded through the hinge structure.

The battery pack may further include a battery case in which the multiple battery arrays and the multiple cooling plates are embedded, wherein a lowermost cooling plate among the multiple cooling plates is configured to form a bottom surface of the battery case.

The battery case may include a crossmember, a cooling plate may be divided based on the crossmember, and parts into which the cooling plate is divided may have cooling flow paths connected through a connection channel.

A through-pipe extending in an upward/downward direction may be provided in the battery case, the through-pipe may be disposed in a space between the battery arrays, and the through-pipe may extend through the cooling plate in the upward/downward direction.

The cooling plate provided between the battery arrays may have interiors which have flow paths and are spaced apart from each other to enable the crossmember to be inserted into the cooling plate, and the spaced interiors are connected to each other by a connecting channel to enable coolant to flow.

The battery pack may further include a cooling port which has a final inlet, a final outlet, an inlet manifold branched from the final inlet, and an outlet manifold branched from the final outlet, the inlet manifold of the cooling port may be connected to each of multiple inlet-side cooling pipes, and the outlet manifold of the cooling port may be connected to each of multiple outlet-side cooling pipes.

The multiple inlet-side cooling pipes may be disposed to gather together at one side on the same plane, the multiple outlet-side cooling pipes may be disposed to gather together at the other side on the same plane, the inlet manifold of the cooling port may be disposed on one side and connected to the inlet-side cooling pipes, and the outlet manifold of the cooling port may be disposed on the other side and connected to the outlet-side cooling pipes.

The multiple cooling pipes and the inlet manifold and the outlet manifold of the cooling port may be disposed on the same plane.

The cooling port may include a fastening bracket that is coupled to the battery case, the final inlet and the final outlet may be connected to an outer side of the fastening bracket, and the inlet manifold and the outlet manifold may be disposed on an inner side of the fastening bracket.

According to the battery pack structure of embodiments of the present disclosure, especially when cooling the prismatic battery cells, the cooling plates are in contact with both sides of the battery cells, so that the cooling efficiency may be maximized, and at the same time, the overapplication of unnecessary cooling plates is prevented, so that the system cost and weight may be prevented from increasing.

A flow path of a cooling plate is formed horizontally, and thus the flow path for coolant is simple. Therefore, the cooling efficiency may be prevented from decreasing due to an increase in flow resistance and a decrease in flow rate caused by an increase in cooling flow path complexity. In addition, the coolant outlet and inlet of a cooling plate of each layer is placed on one plane, and thus the configuration of a cooling port is simplified, space is saved, and fastening is easy.

Since cooling plates are connected to each other in parallel through a cooling port, the coolant temperature difference between the plates is small, so the overall heat balancing of the battery pack may be well maintained.

Furthermore, the elements constituting the battery pack are sequentially assembled in the direction in which the swelling of a battery cell occurs, and thus unnecessary processes are eliminated, thereby reducing process difficulty.

### BRIEF DESCRIPTION OF THE DRAWINGS

The above and other aspects, features, and advantages of embodiments of the present disclosure will be more apparent from the following detailed description taken in conjunction with the accompanying drawings, in which:

FIG. 1 is a perspective view of a battery pack according to an embodiment of the present disclosure;

FIG. 2 is an exploded perspective view of the battery pack illustrated in FIG. 1;

FIG. 3 illustrates cooling pipes of the battery pack illustrated in FIG. 1;

FIG. 4 is a perspective view of a battery array of the battery pack illustrated FIG. 1;

FIG. 5 is a perspective view of a sensing block of the battery array illustrated in FIG. 4;

FIG. 6 illustrates a cooling plate of the battery pack illustrated in FIG. 1;

FIG. 7 is a perspective view of a battery case of the battery pack illustrated FIG. 1; and

FIG. 8 illustrates a state in which the battery pack and the cooling port illustrated in FIG. 1 are dissembled.

### DETAILED DESCRIPTION OF ILLUSTRATIVE EMBODIMENTS

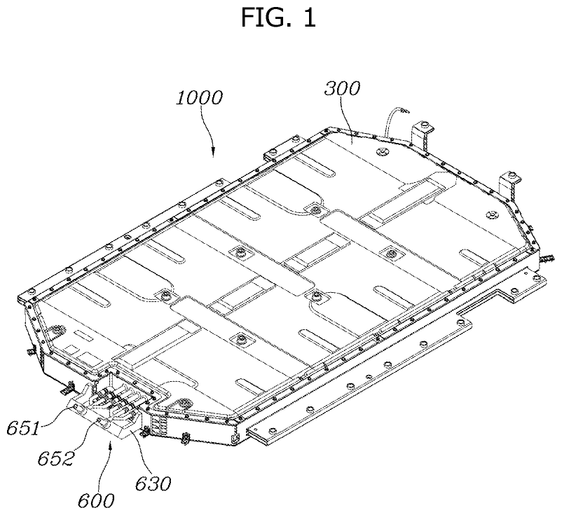

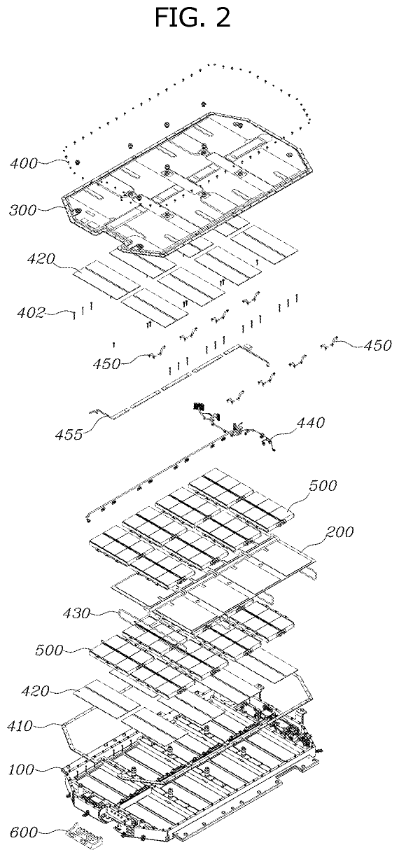

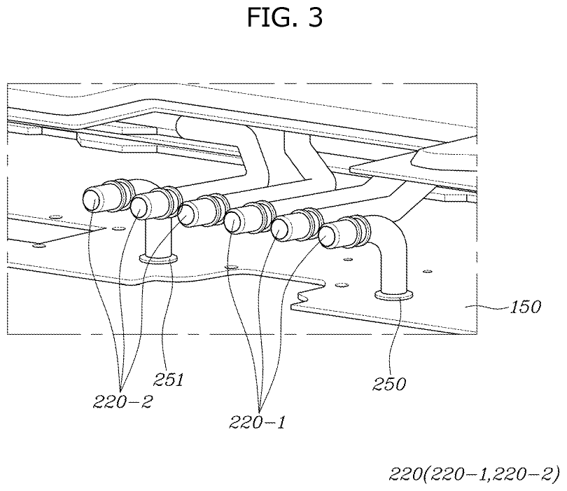

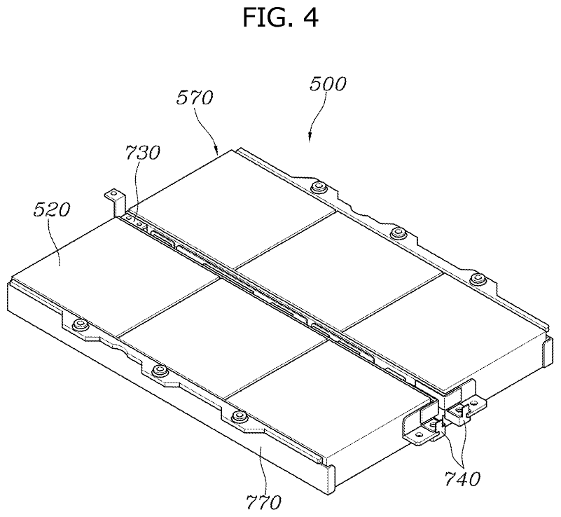

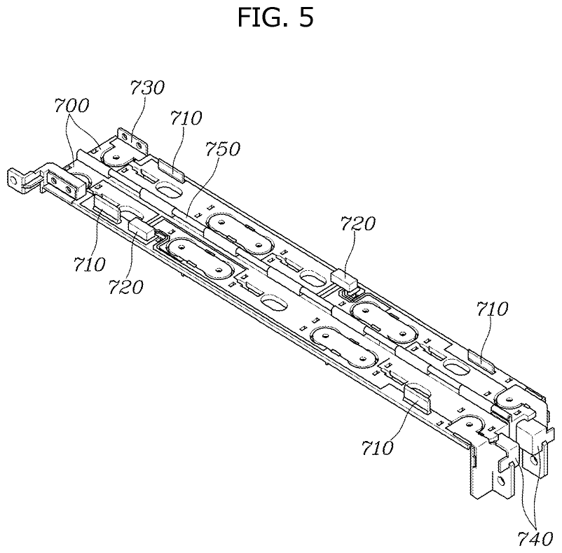

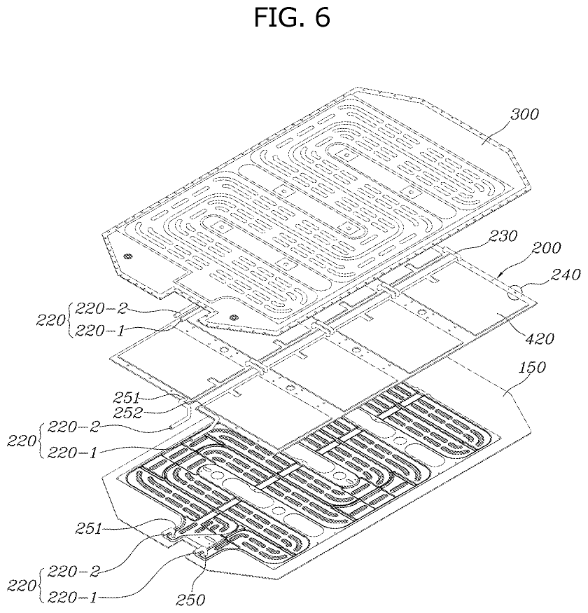

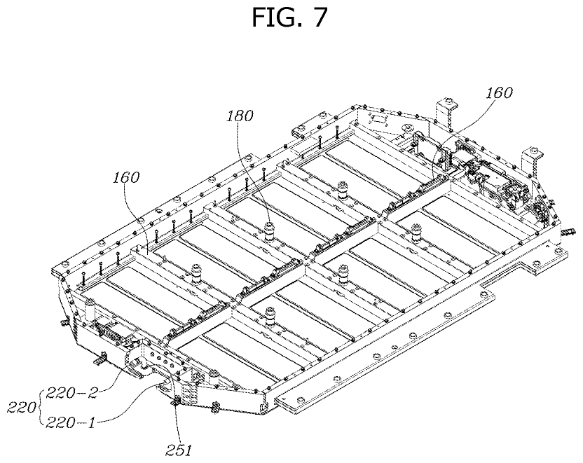

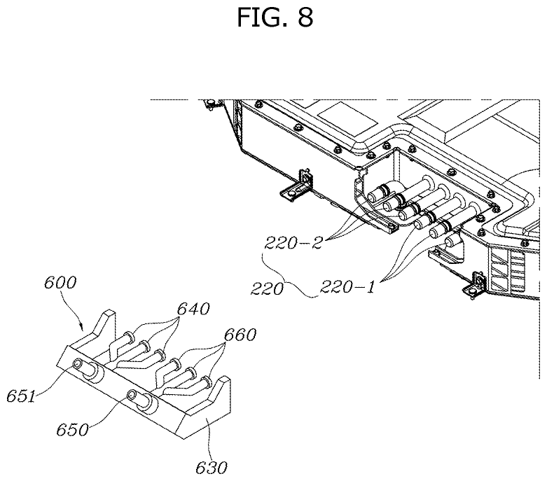

FIG. 1 is a perspective view of a battery pack according to an embodiment of the present disclosure. FIG. 2 is an exploded perspective view of the battery pack illustrated in FIG. 1. FIG. 3 illustrates cooling pipes of the battery pack illustrated in FIG. 1. FIG. 4 is a perspective view of the battery array of the battery pack illustrated FIG. 1. FIG. 5 is a perspective view of a sensing block of the battery array illustrated in FIG. 4. FIG. 6 illustrates a cooling plate of the battery pack illustrated in FIG. 1. FIG. 7 is a perspective view of a battery case of the battery pack illustrated FIG. 1. FIG. 8 illustrates a state in which the battery pack and the cooling port illustrated in FIG. 1 are dissembled.

Hereinafter, specific embodiments of the present disclosure will be described with reference to the accompanying drawings. However, this is only an example and the embodiments of the present disclosure are not limited thereto. In describing embodiments of the present disclosure below, a detailed description of the known technology related to the embodiments of the present disclosure will be omitted when it is determined that the detailed description may unnecessarily obscure the subject matter of the embodiments of the present disclosure. The terms as described below are defined in consideration of functions in the present specification, and the meaning of the terms may vary according to the intention of a user or operator, convention, or the like. Therefore, the definitions of the terms should be made based on the contents throughout the specification. The technical idea of embodiments of the present disclosure is determined by the claims, and the following embodiments are merely a means for efficiently explaining the technical idea of embodiments of the present disclosure to those skilled in the art to which the present disclosure belongs.

A battery pack 1000 according to an embodiment of the present disclosure will be described with reference to FIGS. 1 to 3. The battery pack 1000 according to an embodiment of the present disclosure includes multiple battery arrays 500 stacked in a height direction, multiple cooling plates disposed between the battery arrays 500 to exchange heat with the battery arrays 500 by surface contact with the battery arrays 500, each cooling plate having a cooling flow path formed therein and having an inlet 250 and an outlet 251 which are connected to the cooling flow path, and multiple cooling pipes 220 having one-side ends, which are connected to an inlet and an outlet of each cooling plate, and the other-side ends, which are bent to gather at one point and arranged on the same plane.

In the prior art, a prismatic battery cell cannot be cooled on both surfaces because positive and negative tabs are exposed at the top of the battery cell. Therefore, prismatic battery cells were arranged vertically and either bottom cooling, which cools only the bottom, or side cooling, which cools the side surfaces of individual battery cells, were applied. In the case of conventional bottom cooling, the area of contact between a battery cell and a cooling plate is small, resulting in low cooling efficiency, and in the case of side cooling, a flow path is formed in a vertical direction, resulting in high flow resistance and poor assembly.

Also, in the prior art, a coolant inlet and a coolant outlet are arranged in series, or coolant is distributed to a cooling plate through one inlet and flows out through one outlet. In this case, in the cooling plate of each layer, a temperature difference occurs depending on a relative distance to the coolant inlet and the coolant outlet. When the relative distance to the coolant inlet is close, relatively low-temperature coolant is introduced, but when the relative distance to the coolant inlet is far, high-temperature coolant is introduced, resulting in a temperature difference.

Furthermore, when the relative distance to the coolant outlet is close, heat exchange with high-temperature coolant occurs, and when the relative distance to the coolant outlet is far, heat exchange with low-temperature coolant occurs, further increasing the temperature variation due to the distance. As a result, the temperature variation between battery cells increases, thereby reducing the efficiency and stability of a battery.

Referring to FIG. 3, according to embodiments of the present disclosure, the inlet 250 and the outlet 251 for coolant are connected to the cooling pipes 220 and the ends of the cooling pipes 220 are gathered at one point and arranged horizontally and in parallel on the same plane. Therefore, the coolant flows into and out of the cooling plate of each layer with a small temperature difference. Furthermore, since the cooling pipes 220 are arranged horizontally and in parallel, the coolant flow resistance is low, thereby increasing the cooling efficiency.

FIG. 2 illustrates an exploded view of the battery pack 1000. The battery pack 1000 is formed by sequentially stacking the cooling plates and the battery arrays 500 in a height direction. Since the elements of the battery pack 1000 are stacked and assembled in the direction of the swelling of the battery cells 520, the swelling phenomenon may be prevented. Since the components of the battery pack 1000 are stacked and assembled sequentially, the unnecessary process of forcibly inserting the elements of the battery pack may be eliminated. Therefore, the process difficulty is reduced, and assembly fairness may be secured.

Furthermore, the cooling plates form a sandwich structure with the battery arrays 500 to exchange heat with both surfaces of each of the battery arrays 500. This increases the area for exchanging heat with the battery arrays 500, thereby improving cooling efficiency.

Referring to FIG. 2, in the battery pack according to an embodiment of the present disclosure, when the cooling plates and battery arrays 500 are sequentially stacked, a sealing gasket 410 is inserted to improve the finishing of the battery case, and then a finishing bolt 400 is tightened to improve a fixing force.

The battery arrays 500 will be described with reference to FIG. 4. Each of the battery arrays 500 may include multiple battery modules 570 arranged in a horizontal direction, each of the battery modules 570 includes a sensing block 700 and multiple battery cells 520 arranged in a horizontal direction, and the battery modules 570 adjacent to each other may be disposed such that the sensing blocks 700 face each other to constitute the battery array 500.

The battery cells 520 are arranged horizontally to form the battery array 500. Therefore, an area for heat exchange between a cooling plate and the battery array 500 is increased, thereby improving cooling efficiency.

Since the battery modules 570 are disposed such that the sensing blocks 700 face each other, the connection structure of a central bus bar 455 and the connection structure of a communication wire 440 in the battery pack 1000 are simply configured, thereby simplifying a process.

A battery array 500 stacked in the height direction is connected to a battery array 500 of a neighboring layer by connection bus bars 450. The battery arrays 500 of respective layers are connected to each other by the connection bus bars 450 so that current flows in a direct current structure, thus enabling the battery to provide more power.

When all of the battery arrays 500 are completely stacked, the battery arrays 500 are fastened with fastening bolts 402 to improve the fixing force of the battery arrays in the battery pack.

The sensing blocks 700 will be described with reference to FIG. 5. The sensing blocks 700 each connect connected battery cells 520 in series. The sensing blocks 700 facing each other in the battery array 500 have adjacent one-side portions electrically connected to each other and the other-side portions exposed to form terminals 740 so that multiple battery cells 520 constituting the battery array 500 are connected to each other in series.

The sensing blocks 700 connect the connected battery cells 520 in series, the connection terminals 730 of the sensing blocks 700 facing each other overlap and are mechanically fastened to each other to provide a fixing force, and the sensing blocks 700 are electrically connected to each other to connect, in series, the multiple battery cells 520 constituting the battery array 500, thereby enabling the battery to provide more power.

Each of the sensing blocks 700 has a connection terminal 730 formed on one side and a terminal 740 on the other side and is connected to a facing sensing block 700 through a hinge structure 750. The sensing block 700 is connected to the facing sensing block 700 through the hinge structure 750, thereby preventing a step from occurring when the battery cells 520 form the battery array 500. Accordingly, the stability of the battery array 500 is improved. In addition, since the multiple battery cells 520 are coupled to each other by the sensing blocks combined into one, the difficulty of the process is reduced.

On a side opposite a side at which each of the sensing blocks 700 is coupled to the multiple battery cells 520, a fixing bracket 770 for fixing the multiple battery cells 520 is coupled to the battery cells 520. The fixing bracket 770 is mounted to fix the battery cells 520, and a battery case 100, which will be described later, and the fixing bracket 770 are coupled to each other by the fastening bolts 402, so that the battery array 500 cannot be separated from the battery case 100 by external forces.

The sensing blocks 700 each have fastening portions 710 formed on outer sides thereof. The fastening portions 710 are fastened to each other when the sensing blocks 700 are folded through the hinge structure 750 to keep the sensing blocks 700 facing each other, thereby increasing the stability of the battery pack 1000.

A sensing connector 720 is provided on the outer side of each of the sensing blocks 700. The sensing connector 720 is formed to be exposed outward when the sensing blocks 700 are folded through the hinge structure 750. The outward exposure of the sensing connector 720 enables sensing wire 430 to be easily connected to the sensing connector 720.

Referring to FIG. 6, an embodiment of the present disclosure applies a lowermost cooling plate 150, a central cooling plate 200, and an uppermost cooling plate 300. However, it is obvious that embodiments of the present disclosure are not only applied to the three-stage cooling plate, but also applied to more stacked cooling plates.

Gap fillers 420 are applied to the top and bottom surfaces of the cooling plate to prevent gaps between the cooling plate and the battery array 500 and to absorb and control a reaction force that occurs when the battery cells 520 swell.

Referring to FIG. 7, the battery pack 1000, which is an embodiment of the present disclosure, further includes a battery case 100 in which multiple battery arrays 500 and multiple cooling plates are embedded, and a lowermost cooling plate 150, among the multiple cooling plates, forms the bottom surface of the battery case 100.

The battery case 100 includes a crossmember 160. The crossmember 160 is formed to disperse impact caused by an external force so that the battery cells 520 embedded in the battery case 100 may be prevented from being deformed or damaged.

A through-pipe 180 extending in an upward/downward direction is provided in the battery case 100, the through-pipe 180 is disposed in a space between the battery arrays 500, and the through-pipe 180 extends through the cooling plates in the upward/downward direction. The through-pipe 180 enables the battery pack 1000 to be fixed to a vehicle and also extends through the space between the battery arrays 500 and the cooling plates, thereby having the effect of fixing the battery arrays 500 and the cooling plates.

Referring to FIG. 6, the central cooling plate is divided based on the crossmember 160, and parts into which the cooling plate is divided are formed to have cooling flow paths connected through a connection channel 230. The central cooling plate 200 is divided to enable the crossmember 160 to be inserted, and thus cooling plates may be sequentially stacked, thereby reducing the difficulty of the process.

The central cooling plate 200 has through portions 240 so that the fixing brackets 770 of the battery arrays 500 disposed one above the other with the central cooling plate 200 interposed therebetween are fastened together with the central cooling plate 200. Since the multiple battery arrays 500 are fastened together with the cooling plates, the process is simplified and the internal rigidity of the battery pack 1000 is increased.

Referring to FIG. 8, the cooling pipes 220 of a cooling plate of each layer are connected to a cooling port 600. The cooling port 600 includes a final inlet 650, a final outlet 651, an inlet manifold 660 branched from the final inlet 650, and an outlet manifold 640 branched from the final outlet 651. The inlet manifold 660 of the cooling port 600 is connected to each of multiple inlet-side cooling pipes 220-1, and the outlet manifold 640 of the cooling port 600 is connected to each of multiple outlet-side cooling pipes 220-2. Since coolant is distributed through one final inlet 650 of the cooling port 600, the hydraulic pressure may be strong and the temperature difference of the coolant may be reduced. In addition, since the coolant flows in and out through one final inlet 650 and one final outlet 651, control and management are convenient.

The multiple inlet-side cooling pipes 220-1 are arranged to gather together at one side on the same plane, and the multiple outlet-side cooling pipes 220-2 are arranged to gather together at the other side on the same plane. The inlet manifold 660 of the cooling port 600 is disposed on one side so as to be connected to the inlet-side cooling pipes 220-1, and the outlet manifold 640 of the cooling port is disposed on the other side so as to be connected to the outlet-side cooling pipes 220-2.

The inlet-side cooling pipes 220-1 and the inlet manifold 660 of the cooling port, through which the coolant is introduced, are arranged together on one side, and the outlet-side cooling pipes 220-2 and the outlet manifold 640 of the cooling port, through which the coolant flows out, are arranged together on the other side. Therefore, the cooling pipes may be formed uncomplicatedly, and the process may be simplified.

The multiple cooling pipes 220 and the inlet manifold 660 and the outlet manifold 640 of the cooling port are arranged on the same plane so that the cooling port 600 may be easily fastened to the multiple cooling pipes 220.

The cooling port includes a fastening bracket 630 that is fastened to the battery case 100, the final inlet 650 and the final outlet 651 are connected to the outer side of the fastening bracket 630, and the inlet manifold 660 and the outlet manifold 640 are disposed on the inner side of the fastening bracket 630.

Since the fastening bracket 630 is provided, coolant leakage and external deformation due to deformation of the inlet manifold 660 and the outlet manifold 640 of the cooling port by an external force applied to the side are prevented, thereby promoting stability.

The technical idea of embodiments of the present disclosure has been examined through the above several embodiments. Although not explicitly shown or described in the above embodiments, those skilled in the art to which the present disclosure belongs may make various modifications, including the technical idea of embodiments of the present disclosure, from the description of the present disclosure, and these still fall within the scope of the present disclosure. The above embodiments described with reference to the accompanying drawings have been described for the purpose of illustrating embodiments of the present disclosure, and the scope of the present disclosure is not limited to these embodiments.

What is claimed is:

1. A battery pack comprising:
a plurality of battery arrays stacked in a height direction;
a plurality of cooling plates disposed between the battery arrays to exchange heat with the battery arrays by surface contact with the battery arrays, each cooling plate having a cooling flow path disposed therein and having an inlet and an outlet which are connected to the cooling flow path; and
a plurality of cooling pipes having first side ends connected to the inlet and the outlet of each cooling plate and second side ends bent to gather at one point and arranged on a same plane.

2. The battery pack of claim 1, wherein each of the battery arrays comprises a plurality of battery modules arranged in a horizontal direction, each of the battery modules comprises a sensing block and a plurality of battery cells arranged in the horizontal direction, and the battery modules adjacent to each other are disposed such that the sensing blocks face each other to constitute a respective one of the battery arrays.

3. The battery pack of claim 2, further comprising a fixing bracket coupled to each of both side surfaces of the battery array opposite the sensing blocks, wherein the fixing brackets of the battery arrays vertically disposed with the cooling plate interposed therebetween are fastened together to the cooling plate.

4. The battery pack of claim 2, wherein each sensing block is configured to connect connected ones of the battery cells in series, and the facing sensing blocks of the battery array have adjacent first side portions electrically connected to each other and second side portions exposed to define terminals such that the plurality of battery cells constituting the battery array are connected to each other in series.

5. The battery pack of claim 2, wherein connection terminals are disposed on one side of each sensing block, and wherein the connection terminals are electrically connected to each other by being mechanically fastened while overlapping each other.

6. The battery pack of claim 2, wherein the sensing blocks arranged to face each other are connected to each other through a hinge structure so as to be unfolded or folded, and wherein the sensing blocks are configured to face each other in a folded state.

7. The battery pack of claim 6, wherein the sensing blocks connected through the hinge structure have respective fasteners disposed on outer sides thereof, and in a state in which the sensing blocks are folded through the hinge structure, the respective fasteners are fastened to each other while facing each other so as to keep the sensing blocks facing each other.

8. The battery pack of claim 6, further comprising sensing connectors disposed on an outer side of each sensing block such that each of the sensing connectors is exposed outward in a state in which the sensing blocks are folded through the hinge structure.

9. The battery pack of claim 1, further comprising a battery case, wherein the battery arrays and the cooling plates are embedded in the battery case, and wherein a lowermost cooling plate among the plurality of cooling plates is configured to form a bottom surface of the battery case.

10. The battery pack of claim 9, wherein the battery case comprises crossmembers, each of the cooling plates is divided based on the crossmembers, and parts into which the cooling plates are divided have cooling flow paths connected through a connection channel.

11. The battery pack of claim 10, further comprising a through-pipe extending in an upward/downward direction in the battery case, wherein the through-pipe is disposed in a space between the battery arrays, and wherein the through-pipe extends through each of the cooling plates in the upward/downward direction.

12. The battery pack of claim 11, wherein each of the cooling plates provided between respective ones of the battery arrays has interiors comprising flow paths and spaced apart from each other to enable the crossmembers to be inserted into the cooling plate, and wherein the spaced interiors are connected to each other by the connection channel to enable a coolant to flow.

13. A battery pack comprising:
a plurality of battery arrays stacked in a height direction;
a plurality of cooling plates disposed between the battery arrays and configured to exchange heat with the battery arrays by surface contact with the battery arrays, each cooling plate having a cooling flow path disposed therein and having an inlet and an outlet which are connected to the cooling flow path;
a plurality of cooling pipes having first side ends connected to the inlet and the outlet of each cooling plate and second side ends bent to gather at one point and arranged on a same plane; and
a cooling port comprising a final inlet, a final outlet, an inlet manifold branched from the final inlet, and an outlet manifold branched from the final outlet, wherein the inlet manifold of the cooling port is connected to each of a plurality of inlet-side cooling pipes, and the outlet manifold of the cooling port is connected to each of a plurality of outlet-side cooling pipes.

14. The battery pack of claim 13, wherein the inlet-side cooling pipes are disposed to gather together at a first side on the same plane, the outlet-side cooling pipes are disposed to gather together at a second side on the same plane, the inlet manifold of the cooling port is disposed on the first side and connected to the inlet-side cooling pipes, and the outlet manifold of the cooling port is disposed on the second side and connected to the outlet-side cooling pipes.

15. The battery pack of claim 13, wherein the cooling pipes and the inlet manifold and the outlet manifold of the cooling port are disposed on the same plane.

16. The battery pack of claim 13, further comprising a battery case, wherein the battery arrays and the cooling plates are embedded in the battery case, and wherein a lowermost cooling plate among the plurality of cooling plates is configured to form a bottom surface of the battery case.

17. The battery pack of claim 16, wherein the cooling port comprises a fastening bracket that is coupled to the battery case, the final inlet and the final outlet are connected to an outer side of the fastening bracket, and the inlet manifold and the outlet manifold are disposed on an inner side of the fastening bracket.

18. The battery pack of claim 16, wherein the battery case comprises crossmembers, each of the cooling plates is divided based on the crossmembers, and parts into which the cooling plates are divided have cooling flow paths connected through a connection channel.

19. The battery pack of claim 18, further comprising a through-pipe extending in an upward/downward direction in the battery case, wherein the through-pipe is disposed in a space between the battery arrays, and wherein the through-pipe extends through each of the cooling plates in the upward/downward direction.

20. The battery pack of claim 19, wherein each of the cooling plates provided between respective ones of the battery arrays has interiors comprising flow paths and spaced apart from each other to enable the crossmembers to be inserted into the cooling plate, and wherein the spaced interiors are connected to each other by the connection channel to enable a coolant to flow.
